(19) United States
(12) Patent Application Publication
(10) Pub. No.: US 2018/0191068 A1
(43) Pub. Date: Jul. 5, 2018

(54) HIGH EFFICIENCY ANTENNA FOR RADIO FREQUENCY COMMUNICATION

(71) Applicant: Changshi Lee, Pomona, CA (US)

(72) Inventor: Changshi Lee, Pomona, CA (US)

(21) Appl. No.: 15/396,635

(22) Filed: Dec. 31, 2016

(51) Int. Cl. H01Q 7/00; H01Q 1/36; H01Q 1/38

(52) U.S. Cl. CPC H01Q 7/00; H01Q 1/38; H01Q 1/36

(57) ABSTRACT

Systems and methods are disclosed for communication radio signals with a first shape in a complete electrical loop; a second shape in an incomplete electrical loop positioned adjacent the first shape; and a radio frequency (RF) unit coupled to one of the shapes.

### BACKGROUND

The present invention relates generally to an antenna for electrical communications.

Antennas are essential components of all equipment that uses radio. They are used in systems such as radio broadcasting, broadcast television, two-way radio, communications receivers, radar, cell phones, and satellite communications, as well as other devices such as garage door openers, wireless microphones, Bluetooth-enabled devices, wireless computer networks, baby monitors, and RFID tags on merchandise.

The antenna converts electric power into radio waves, and vice versa, when used with a radio transmitter or radio receiver. In transmission, a radio transmitter supplies an electric current oscillating at radio frequency (i.e. a high frequency alternating current (AC)) to the antenna's terminals, and the antenna radiates the energy from the current as electromagnetic waves (radio waves). In reception, an antenna intercepts some of the power of an electromagnetic wave in order to produce a voltage at its terminals which is amplified and decoded by a receiver.

Typically an antenna consists of an arrangement of metallic conductors (elements), electrically connected (often through a transmission line) to the receiver or transmitter. An oscillating current of electrons forced through the antenna by a transmitter will create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming radio wave exert force on the electrons in the antenna elements, causing them to move back and forth, creating oscillating currents in the antenna.

Antennas can be designed to transmit and receive radio waves in all horizontal directions equally (omnidirectional antennas), or preferentially in a particular direction (directional or high gain antennas). In the latter case, an antenna may also include additional elements or surfaces with no electrical connection to the transmitter or receiver, such as parasitic elements, parabolic reflectors or horns, which serve to direct the radio waves into a beam or other desired radiation pattern.

### SUMMARY

In one aspect, systems and methods are disclosed for communication radio signals with a first shape in a complete electrical loop; a second shape in an incomplete electrical loop positioned adjacent the first shape; and a radio frequency (RF) unit coupled to one of the shapes.

In another aspect, systems and methods are disclosed for communication radio signals with a first shape in a complete electrical loop; a second shape in an incomplete electrical loop positioned adjacent the first shape; and a radio frequency (RF) unit coupled to the first shape.

In yet another aspect, systems and methods are disclosed for communication radio signals with a first shape in an incomplete electrical loop; a second shape in a complete electrical loop positioned adjacent the first shape; and a radio frequency (RF) unit coupled to the second shape.

The incomplete loop can be within/inside the complete loop in one embodiment, and in another embodiment incomplete loop can be outside the complete loop.

In a further aspect, a wireless communication method includes forming a first shape in a complete loop; forming a second shape in an incomplete loop positioned adjacent the first shape; and transmitting or receiving a radio frequency signal with one of the shapes.

Implementations of the above aspects may include one or more of the following. The shape can include one of: square shape, rectangular shape, circular shape, oval shape, triangular shape, curved shape, and curvilinear shape. Each shape can be formed of printed circuit board traces. The antenna can have alternating closed shape and open shape sub-sections. The alternating closed and open shapes can be spaced apart and lie on a plane. A radio frequency matching circuit or a radio frequency identification (RFID) transponder can be connected to one of the alternating closed and open shapes. A radio frequency matching circuit or a radio frequency identification (RFID) transponder coupled to an inner most shape of said alternating closed and open shapes. The open and closed shapes can include first and second loops that lie within a plane. Wireless transceivers can be to the outermost or innermost shape. The incomplete loop is within/inside the complete loop in one embodiment, and in another embodiment incomplete loop is outside the complete loop.

An advantage of the system is that it can be implemented as a simple structure having a small size, thus making it suitable to serve in applications where a size is a limitation and making its manufacture and materials requirements quite economical.

Another advantage of the system is that it permits a more omni directional antenna pattern than many existing designs, facilitating consistent and reliable transponder detection.

Another advantage of an RFID embodiment is that it is particularly suitable for use in passive-type RFID tags by virtue of its high efficiency. Although, the present invention is also quite suitable and beneficial for use in many active-type RFID tag designs.

These advantages of the system will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended figures of drawings in which:

FIG. 1 shows a first exemplary antenna.

FIG. 2 shows a second exemplary antenna.

FIG. 3 shows a third exemplary antenna.

FIG. 4 shows a fourth exemplary antenna.

FIG. 5 shows a fifth exemplary antenna.

FIG. 6 shows a sixth exemplary antenna.

FIG. 7 shows a seventh exemplary antenna.

FIG. 8 shows an eighth exemplary antenna.

FIG. 9 shows a ninth exemplary antenna.

FIG. 10 shows a tenth exemplary antenna.

FIG. 11 shows an eleventh exemplary antenna.

FIG. 12 shows a twelfth exemplary antenna.

FIG. 13 shows an exemplary wireless system with a suitable antenna from any of FIGS. 1-12.

In the various figures of the drawings, like references are used to denote like or similar elements or steps.

### DESCRIPTION

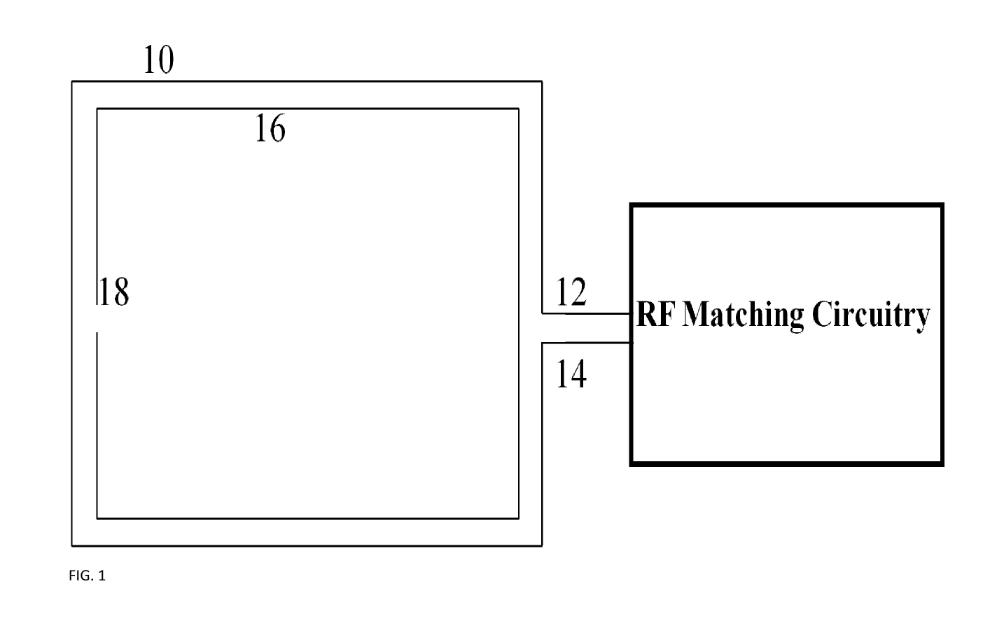

FIG. 1 shows a first exemplary antenna. The antenna has a first substantially rectangular shape 10 with two connection nodes 12 and 14 connected to an RF unit such as an RF matching circuit. A second substantially rectangular shape 16 is formed adjacent the first substantially rectangular shape, however, the second shape has open ends 18 that forms an incomplete loop.

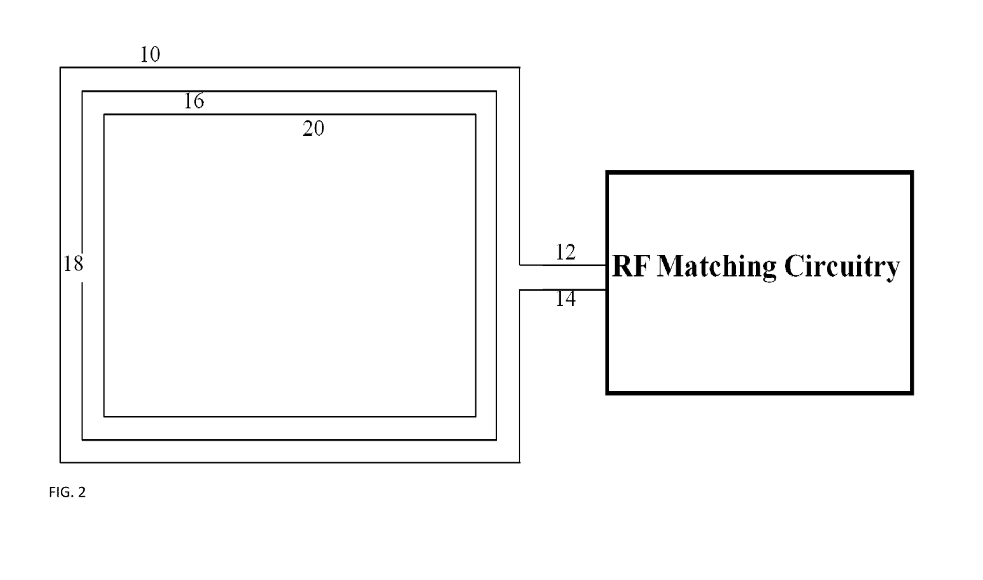

FIG. 2 shows a second exemplary antenna. Similar to the antenna of FIG. 1, the antenna has the first and second substantially rectangular shapes with an adjacent rectangular shape 16 having an incomplete loop. In addition, the antenna of FIG. 2 has a third substantially rectangular shape 20 in a closed loop form.

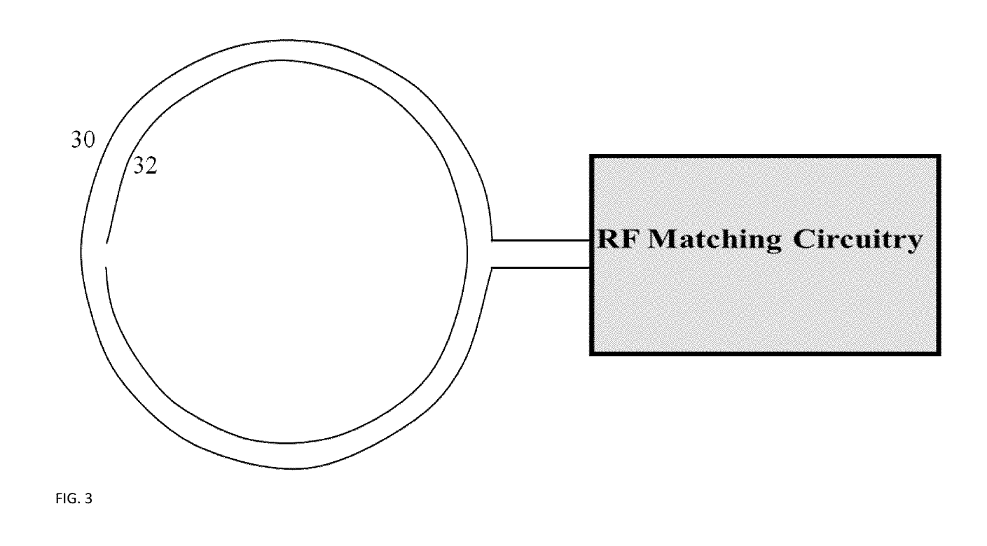

FIG. 3 shows a third exemplary antenna. The antenna has a first substantially circular shape 30 with two connection nodes connected to an RF matching circuit. A second substantially matched shape 32 is formed adjacent the first substantially circular shape, however, the second shape has open ends that forms an incomplete loop.

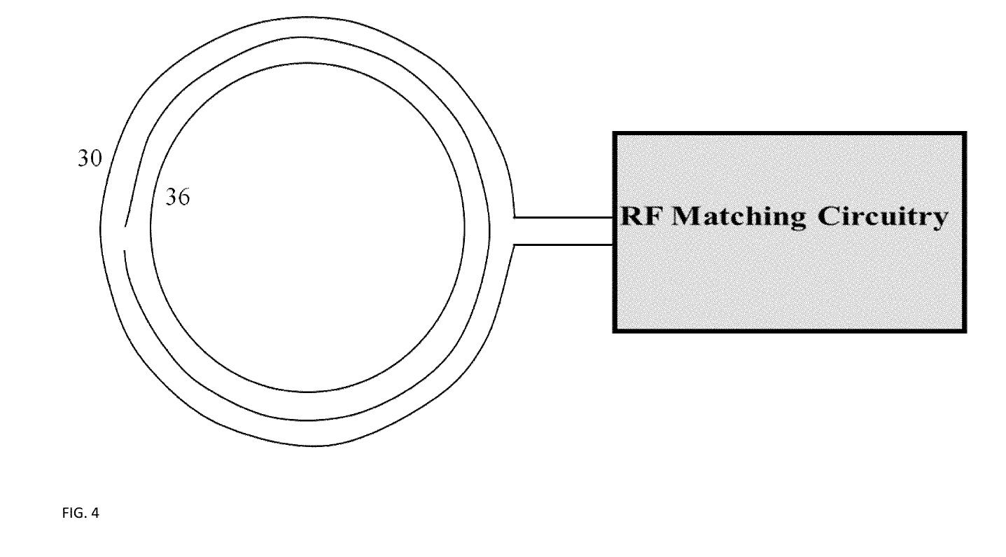

FIG. 4 shows a fourth exemplary antenna. Similar to the antenna of FIG. 3, the antenna has the first and second substantially circular shapes with the adjacent matching shape as an incomplete loop. In addition, the antenna of FIG. 4 has a third substantially matching circular shape 36 in a closed loop form.

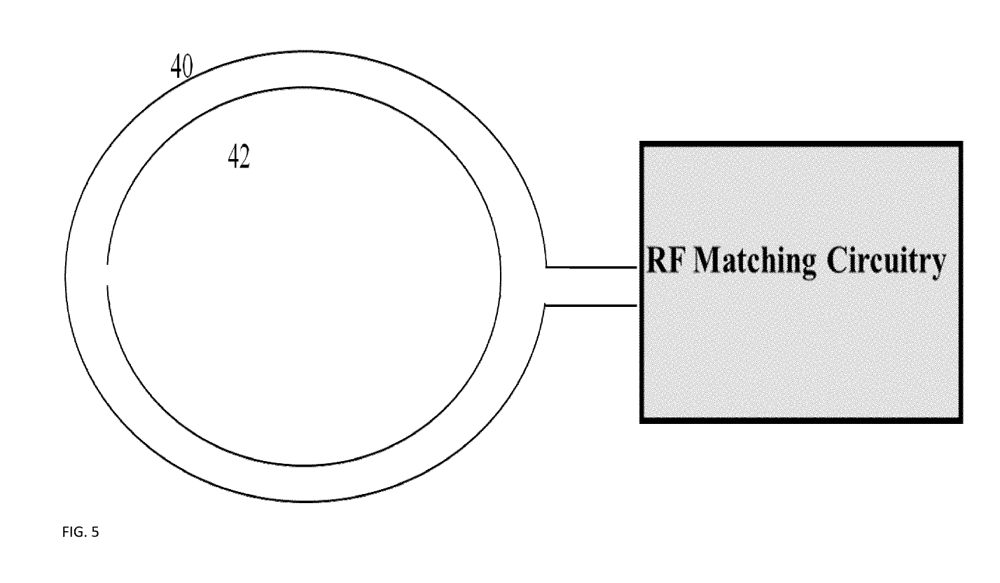

FIG. 5 shows a fifth exemplary antenna. The antenna has a first substantially oval shape 40 with two connection nodes connected to an RF matching circuit. A second substantially matched shape 42 is formed adjacent the first substantially oval shape, however, the second shape 42 has open ends that forms an incomplete loop.

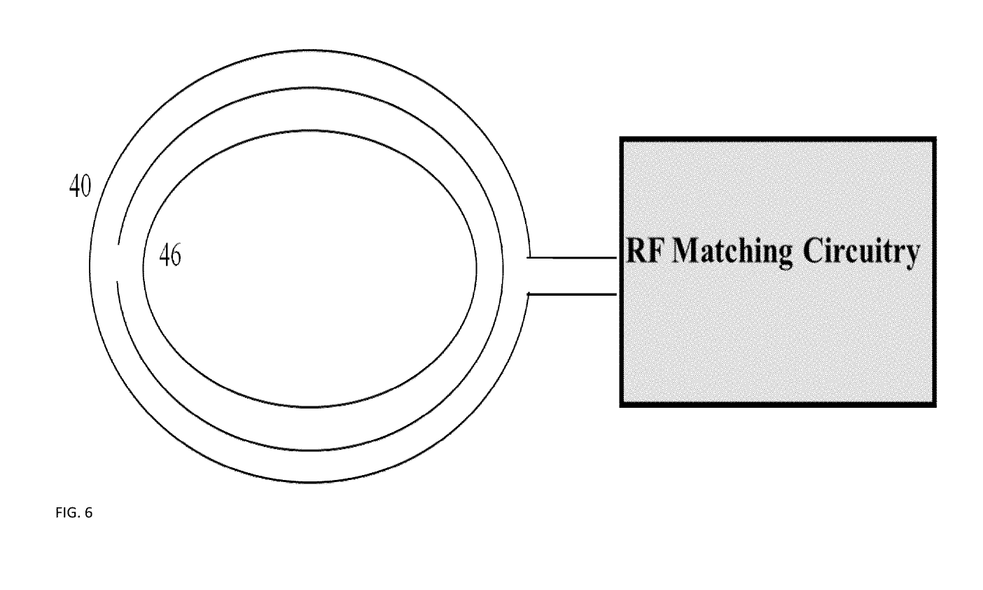

FIG. 6 shows a sixth exemplary antenna. Similar to the antenna of FIG. 5, the antenna has the first and second substantially oval shapes with the adjacent matching shape as an incomplete loop. In addition, the antenna of FIG. 6 has a third substantially matching oval shape 46 in a closed loop form.

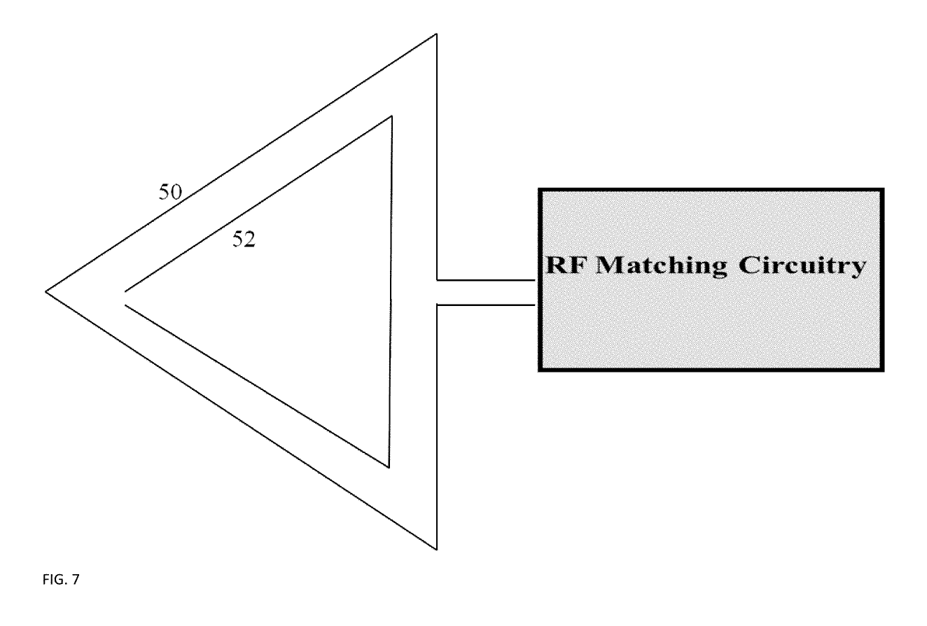

FIG. 7 shows a seventh exemplary antenna. The antenna has a first substantially triangular shape 50 with two connection nodes connected to an RF matching circuit. A second substantially matched shape 52 is formed adjacent the first substantially triangular shape, however, the second shape has open ends that forms an incomplete loop.

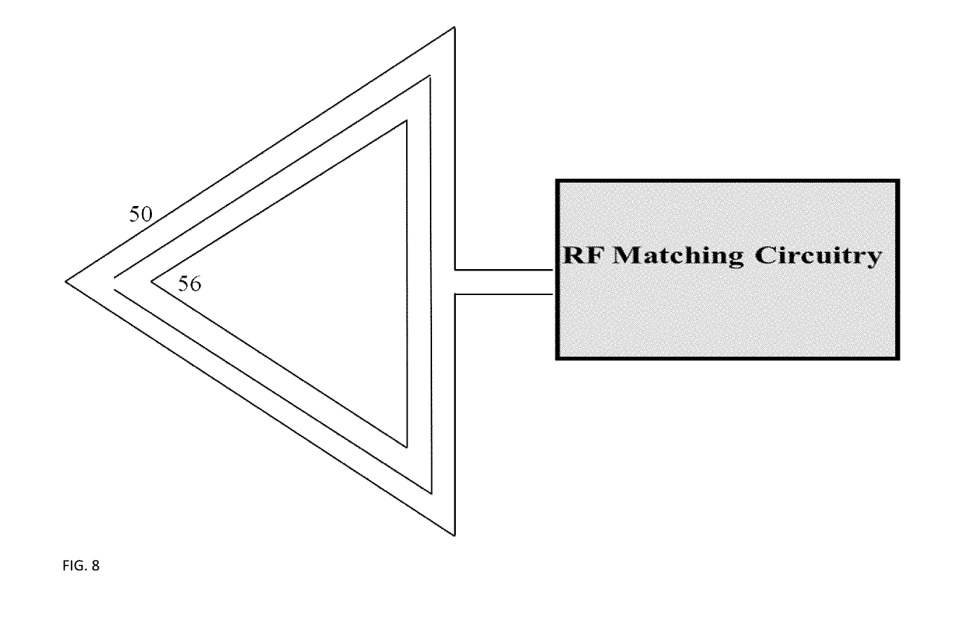

FIG. 8 shows an eighth exemplary antenna. Similar to the antenna of FIG. 7, the antenna has the first and second substantially triangular shapes 50-52 with the adjacent matching shape as an incomplete loop. In addition, the antenna of FIG. 8 has a third substantially matching triangular shape 56 in a closed loop form.

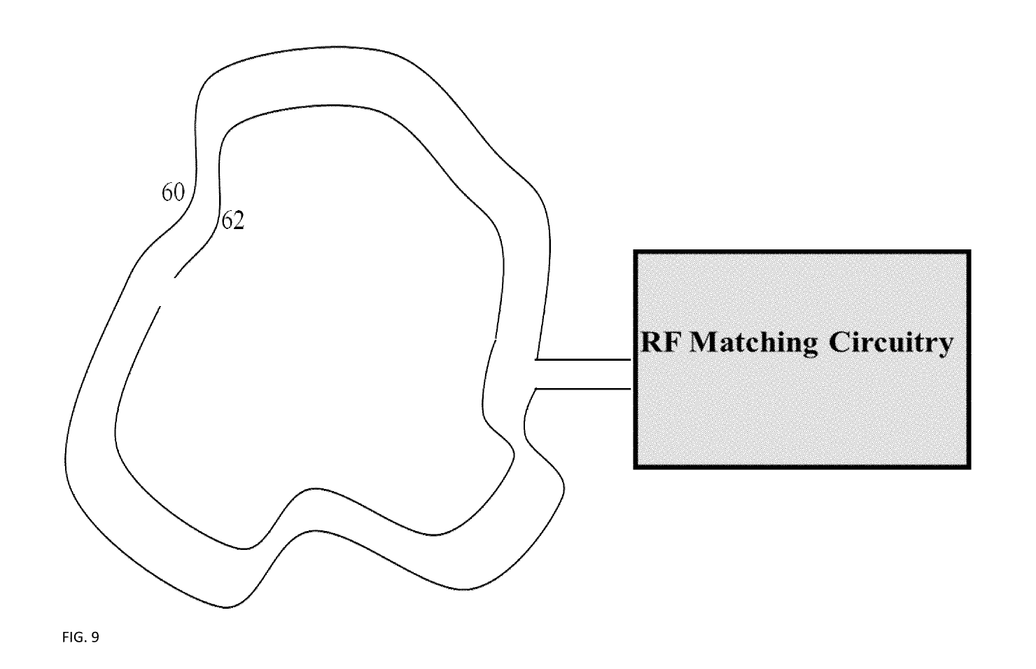

FIG. 9 shows a ninth exemplary antenna. The antenna has a first substantially arbitrary shape 60 with two connection nodes connected to an RF matching circuit. A second substantially matched shape 62 is formed adjacent the first substantially arbitrary shape and is spaced apart a predetermined distance from the arbitrary shape 60, however, the second shape 62 has open ends that forms an incomplete loop.

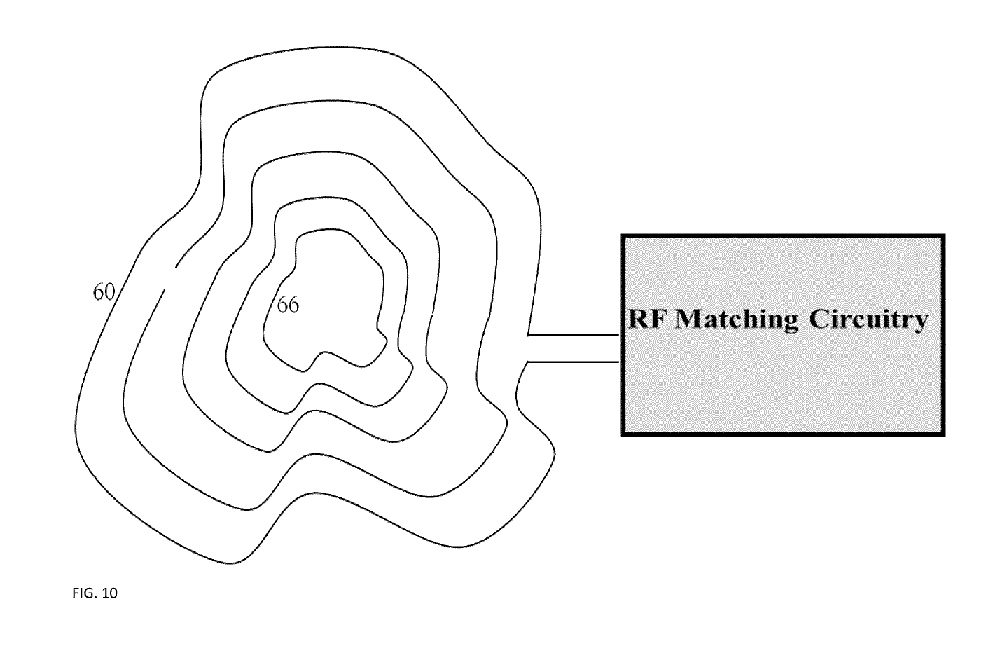

FIG. 10 shows a tenth exemplary antenna. Similar to the antenna of FIG. 9, the antenna has the first and second substantially arbitrary shapes 60-62 with an adjacent matching shape as an incomplete loop. Further, the antenna of FIG. 10 has a plurality of substantially matching arbitrary shapes 66 each in a closed loop form.

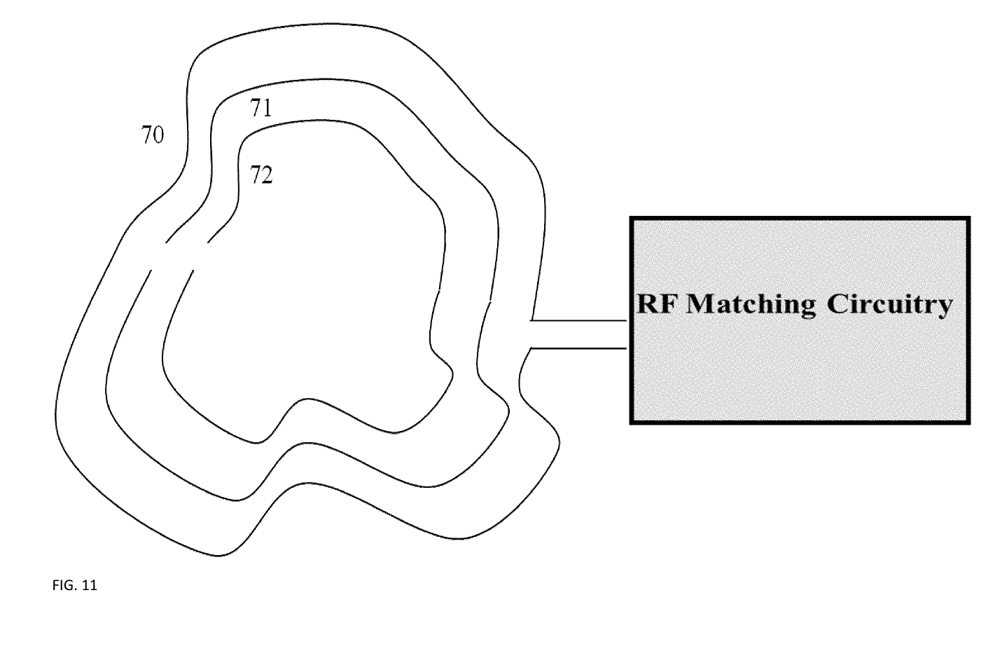

FIG. 11 shows an eleventh exemplary antenna. The antenna has a first substantially arbitrary shape 70 with two connection nodes connected to an RF matching circuit. Two inside substantially matched shapes 71-72 are formed adjacent the first substantially arbitrary shape and is spaced apart a predetermined distance from the arbitrary shape 70, however, the plurality of inside shapes have open ends, each forming an incomplete loop.

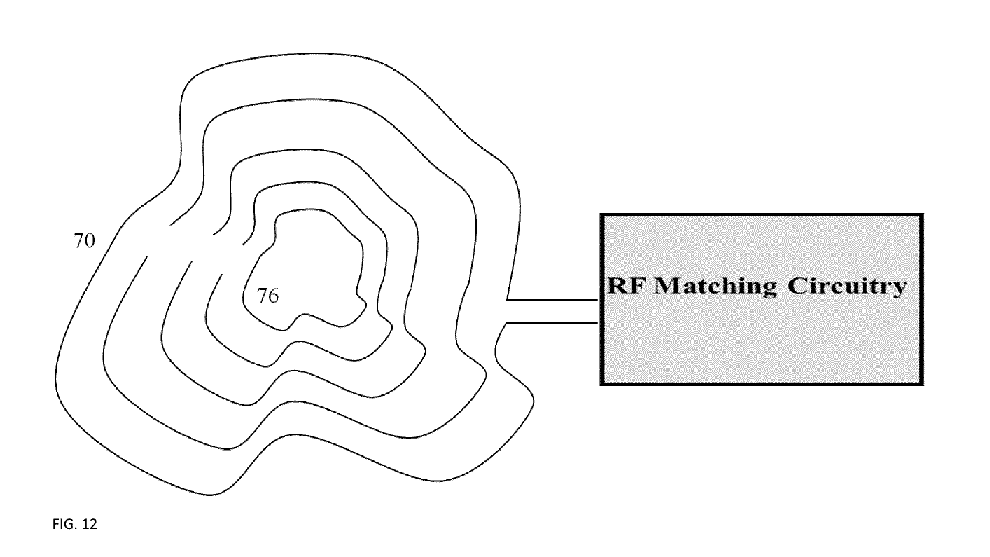

FIG. 12 shows a twelfth exemplary antenna. Similar to the antenna of FIG. 11, the antenna has the first shape 70 and inside substantially arbitrary inside shapes 71 as adjacent matching shapes that are incomplete loops. Further, the antenna of FIG. 12 has another substantially matching arbitrary shape 76 in a closed loop form.

In yet other embodiments of FIG. 12, the antenna has a first substantially arbitrary shape with two connection nodes connected to an RF matching circuit. A second substantially matched shape is formed adjacent the first substantially arbitrary shape and it is spaced apart a predetermined distance from the arbitrary shape with open ends that forms incomplete loop. This pattern can be repeated a number of iterations to form a plurality of complete/incomplete pairs of loops nested within other pairs in a recursive manner.

In further embodiments of FIG. 12, the antenna has a first substantially arbitrary open loop shape with two connection nodes connected to an RF matching circuit. A second substantially matched shape is formed adjacent the first substantially arbitrary shape and it is spaced apart a predetermined distance from the arbitrary shape with closed loops. This pattern can be repeated a number of iterations to form a plurality of incomplete/complete pairs of loops nested within other pairs in a recursive manner.

In further embodiments, the antenna has the first substantially arbitrary shape with a plurality of adjacent matching shapes as incomplete loops. Further, the antenna has another substantially matching arbitrary shape in a closed loop form, followed by a plurality of pairs of matching shape in an incomplete loop and matching shape in a closed loop form.

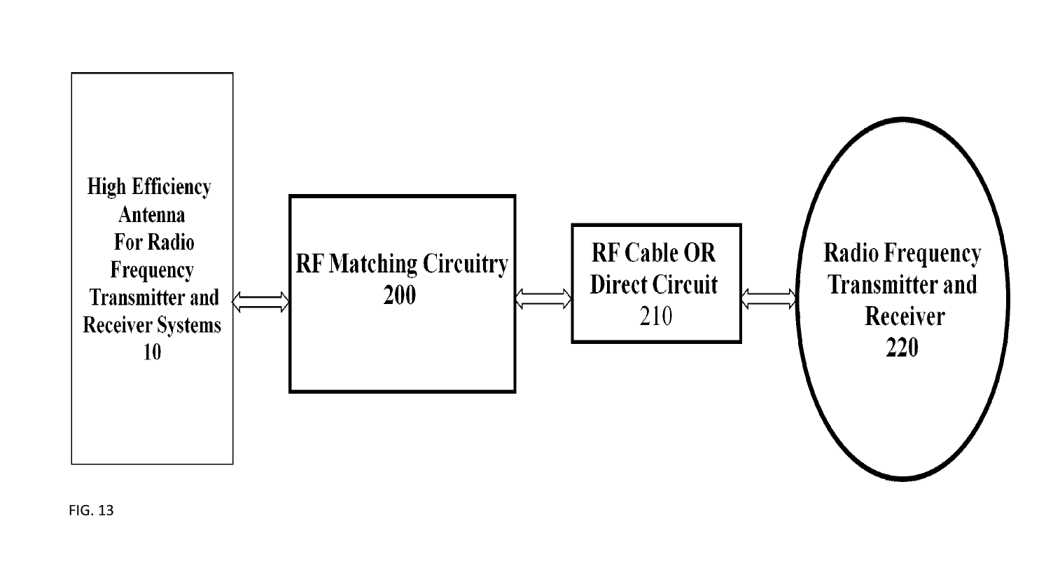

FIG. 13 shows an exemplary wireless system with a suitable antenna from any of FIGS. 1-12. The antenna 10 is connected to an RF matching block 200, which in turn is connected to RF cables, PC traces, or direct connection 210 to an RF transmitter and receiver (transceiver). The antenna can also be used in various example RFID systems with an interrogator and a transponder. In some RFID systems the “identifying” information is written into the transponder during manufacture and never changed, making the interrogator merely a reader. In other systems, however, the identifying information in the transponder can be changed and the interrogator used can then be both a reader and a writer. In view of this, the term “interrogator” is used herein to generically mean a reader, a writer, or both. The terms “transponder” and “tag” have become almost synonymous and are used herein as such.

RFID tags are generally classified by whether they are active or passive. A passive-type RFID tag includes transponder circuitry and an antenna, while an active-type RFID tag additionally includes a power source, such as a battery, fuel-cell, or some equivalent. The circuitry in transponders today is usually embodied in a single integrated circuit, hence the term “transponder chip” is often used. FIG. 16 depicts a passive-type RFID tag. Such tags are used primarily as the examples in this discussion because they are the most commonly used type today and because they will usually benefit more noticeably by use with the present invention. Nonetheless, it should be appreciated that many active-type RFID designs will also benefit by use of the invention.

A passive-type RFID tag extracts energy from an externally provided radio frequency (RF) wave. Typically this RF wave is an interrogation signal being used to excite the antenna to read or write information in the tag. The lack of a built-in energy source tends to make passive RFID tags cheaper to manufacture, longer lasting, and more reliable. This also tends to make them environmentally friendly, because they do not include the environmentally unfriendly substances typically used in power sources. The lack of a built-in energy source, however, also limits the effective operating range of a passive RFID tag with respect to the given energy in an interrogation signal. For example, to increase operating range or if signal propagation between an interrogator and a tag is somehow limited, it follows that the interrogator being used with a passive RFID tag will have to radiate the interrogation signal at a higher power level to accomplish the task at hand.

Unfortunately, simply increasing the power level of an interrogation signal to insure successful interrogator-tag communications is not always possible. For instance, simple inefficiency can exacerbate problems such as battery life and heat dissipation in the interrogator. Of more serious concern, RF energy radiation intended for one system can interfere with other electronic systems and, in extreme cases, can be unsafe for biological systems, e.g., humans, animals, plants, etc. For this reason, most governments limit RF energy radiation levels, and the United States and both Europe are notable in this respect.

The exemplary passive-type RFID tag can use the antenna disclosed above, a matching network, a modulator, a rectifier, and a logic sub-circuit. The antenna is a dipole-type, as is frequently used in RFID systems today. The matching network is shown in a dashed outline because it is optional, as discussed below. The circuitry depicted in the matching network, modulator, and rectifier in FIG. 15 or 16 is merely representative, and no circuitry is depicted in the logic sub-circuit because such can vary considerably and is not particularly germane to this discussion. The antenna and the matching network usually must be implemented in discrete components, but the modulator, rectifier, and logic sub-circuit are usually implemented today as a single integrated circuit “transponder chip”.

Temporarily ignoring the matching network, the antenna is connected to the “front end” of the transponder chip and the electromagnetic field of an interrogation signal that impinges on the antenna must produce an output signal having a voltage above a given threshold before the transponder chip can rectify it.

Rectifying the received interrogation signal can serve multiple purposes. In a passive RFID tag it provides the power needed to operate the logic sub-circuit, and ultimately also the modulator that permits the transponder to “send” its identifying information back to an interrogator as backscatter radiation. Additionally, rectification demodulates the interrogation signal if it is providing information to the transponder. This is so if the logic sub-circuit is being programmed, either with the identifying information that the transponder will “reply” with when later read, or with any other programming that the logic sub-circuit can accept. Additionally, the RF carrier of an interrogation signal may include some indication to transponders that it works with that it is a valid interrogation signal, e.g., a particular sub-carrier frequency. This permits the transponder to remain silent when energized by other, invalid RF signals.

To maximize the voltage produced by the antenna, and to thus increase the energy provided to the transponder, the impedance between the antenna and the transponder should match at the operating frequency of the particular interrogation signal being used. One known approach to improving this impedance matching is to utilize circuits of either discrete components, e.g., inductor and capacitor networks or distributed elements such as microstrip structures. The inductor and capacitor matching network shown in FIG. 1 is an example. Unfortunately, these approaches are often undesirable because they increase the cost, complexity, and size of the RFID tag and decrease its efficiency.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

What is claimed is:

1. An antenna, comprising:
a first shape in a complete electrical loop;
a second shape in an incomplete electrical loop positioned adjacent the first shape; and
a radio frequency (RF) unit coupled to one of the shapes.

2. The antenna of claim 1, wherein shape comprises one of: square shape, rectangular shape, circular shape, oval shape, triangular shape, curved shape, and curvilinear shape.

3. The antenna of claim 1, wherein each shape is formed of printed circuit board traces.

4. The antenna of claim 1, comprising alternating closed shape and open shape sub-sections.

5. The antenna of claim 4, wherein said alternating closed and open shapes are spaced apart and lie on a plane.

6. The antenna of claim 1, comprising a radio frequency matching circuit or a radio frequency identification (RFID) transponder coupled to an outer most shape of said alternating closed and open shapes.

7. The antenna of claim 1, comprising a radio frequency matching circuit or a radio frequency identification (RFID) transponder coupled to an inner most shape of said alternating closed and open shapes.

8. The antenna of claim 1, wherein said open and closed shapes comprise first and second loops that lie within a plane.

9. The antenna of claim 1, comprising transceivers coupled to the outermost or innermost shape.

10. The antenna of claim 1, wherein the RF circuit drives the complete loop, wherein either the incomplete loop is within or inside the complete loop, or the incomplete loop is outside of the complete loop.

11. A wireless communication method, comprising:
forming a first shape in a complete loop;
forming a second shape in an incomplete loop positioned adjacent the first shape; and
transmitting or receiving a radio frequency signal with one of the shapes.

12. The method of claim 11, comprising forming the first and second shapes from one of: square shape, rectangular shape, circular shape, oval shape, triangular shape, curved shape, and curvilinear shape.

13. The method of claim 11, comprising forming each shape as printed circuit board traces.

14. The method of claim 11, comprising forming alternating closed shape and open shape sub-sections.

15. The method of claim 14, wherein said alternating closed and open shapes are spaced apart and lie on a plane.

16. The method of claim 11, comprising applying a radio frequency matching circuit or a radio frequency identification (RFID) transponder to an outer most shape of said alternating closed and open shapes.

17. The method of claim 11, comprising applying a radio frequency matching circuit or a radio frequency identification (RFID) transponder to an inner most shape of said alternating closed and open shapes.

18. The method of claim 11, wherein said open and closed shapes comprise first and second loops that lie within a plane.

19. The method of claim 11, comprising transmitting or receiving signals with the outermost or innermost shape.

20. The method of claim 11, wherein the incomplete loop is within or inside the complete loop.

21. The method of claim 11, wherein the complete loop is within or inside the incomplete loop.
